(19) United States
(12) Patent Application Publication
(10) Pub. No.: US 2026/0001423 A1
(43) Pub. Date: Jan. 1, 2026

(54) METHOD OF PRECONDITIONING ON-BOARD CHARGING EQUIPMENT AND VEHICLE INCLUDING THE SAME

(71) Applicant: GM GLOBAL TECHNOLOGY OPERATIONS LLC, Detroit, MI (US)

(72) Inventor: Cole Reinhold, Linden, MI (US)

(73) Assignee: GM GLOBAL TECHNOLOGY OPERATIONS LLC, Detroit, MI (US)

(21) Appl. No.: 18/760,078

(22) Filed: Jul. 1, 2024

(51) Int. Cl. B60L 53/22; H02J 7/00

(52) U.S. Cl. CPC B60L 53/22; H02J 7/00032; B60L 2210/30; B60L 2210/40

(57) ABSTRACT

A method of preconditioning on-board charging equipment for a vehicle including a rechargeable energy storage system (RESS) includes: determining whether a vehicle charging event will occur within a predetermined period of time; determining whether an initial temperature of the on-board charging equipment is below a first predetermined temperature; and increasing the initial temperature of the on-board charging equipment prior to the vehicle charging event when it is determined that the vehicle charging event will occur within the predetermined period of time and the initial temperature of the on-board charging equipment is below the first predetermined temperature, wherein the initial temperature of the on-board charging equipment is increased using a charging and discharging loop.

### INTRODUCTION

The concepts described herein relate generally vehicles including rechargeable energy storage systems (RESS), and a method of preconditioning on-board charging equipment, which is operable to increase an initial temperature of the on-board charging equipment to a predetermined temperature prior to commencement of a vehicle charging event.

Each RESS includes a plurality of battery cell groups or packs, with each battery cell group including a plurality of battery cells, for example, lithium-ion battery cells, on-board charging equipment, integral to or in communication with the RESS, and a cooling system including a coolant loop.

At cold ambient temperatures, the on-board charging equipment must complete a warmup period that commences contemporaneously with initiation of the vehicle charging event, which results in a slow initial charging speed at the beginning of the vehicle charging event.

Additionally, the warmup period may not be successful at increasing the temperature of the on-board charging equipment to a temperature where the initial charging speed is increased, as effectiveness of the warmup period is, at least in part, based on proximity of the on-board charging equipment to the coolant loop.

As such, it would be beneficial for the temperature of the on-board charging components to be increased to a predetermined temperature, prior to initiation and/or commencement of the vehicle charging event, that provides increased charging speed and effectiveness of the charging prior to initiation and/or commencement of the vehicle charging event.

### SUMMARY

In view of the above discussion, it is useful to develop a method of preconditioning on-board charging equipment of a vehicle including a rechargeable energy storage system (RESS), which is operable to increase a temperature of the on-board charging equipment to a predetermined temperature, prior to initiation and/or commencement of a vehicle charging event, to increase initial charging speed and effectiveness of charging during the vehicle charging event.

A method of preconditioning on-board charging equipment for a vehicle including a rechargeable energy storage system (RESS) is disclosed. The method may include determining whether a vehicle charging event will occur within a predetermined period of time; determining whether an initial temperature of the on-board charging equipment is below a first predetermined temperature; and increasing the initial temperature of the on-board charging equipment prior to the vehicle charging event when it is determined that the vehicle charging event will occur within the predetermined period of time and the initial temperature of the on-board charging equipment is below the first predetermined temperature, wherein the initial temperature of the on-board charging equipment is increased using a charging and discharging loop.

The on-board charging equipment may include at least two on-board charging modules (OBCMs), while increasing the initial temperature of the on-board charging equipment may further include: turning on communication between the at least two OBCMs and the controller when it is determined that the vehicle charging event will occur within the predetermined period of time and the at least two OBCMs are below the first predetermined temperature; and connecting the at least two OBCMs to a high-voltage bus.

The at least two OBCMs may include a first OBCM and a second OBCM, and the method may further include: enabling the first OBCM in an AC output mode; and enabling the second OBCM in a DC output mode.

The first OBCM may be operable to convert direct current (DC) power from the RESS to alternating current (AC) power, and the second OBCM may be operable to convert AC power from the first OBCM to DC power.

The method may further include delivering, via the high-voltage bus, DC power from the second OBCM to a low-voltage auxiliary device.

According to an aspect of the disclosure, the charging and discharging loop may include: receiving, via the first OBCM, DC power from the RESS; converting, via the first OBCM, the DC power from the RESS to AC power; delivering, via the high-voltage bus, the AC power from the first OBCM to the second OBCM; converting, via the second OBCM, the AC power from the first OBCM to DC power; and delivering, via the high-voltage bus, the DC power from the second OBCM back to the RESS.

The charging and discharging loop may be cycled repeatedly to increase the initial temperature of the on-board charging equipment.

The repeated cycling of the charging and discharging loop is discontinued when the initial temperature of the on-board charging equipment reaches a second predetermined temperature or a vehicle charging event indicator is received.

The method may further include disconnecting the at least two OBCMs from the high-voltage bus; and turning off communication between the at least two OBCMs and the controller when the repeated cycling of the charging and discharging loop is discontinued.

The vehicle charging event indicator may include a charge port door open indicator.

The preconditioning may occur when the vehicle is not connected to an AC power source, or when the vehicle is connected to the AC power source and a diverter switch, in communication with the vehicle and the AC power source, is in an open position.

According to another aspect of the disclosure, a rechargeable energy storage system (RESS) for a vehicle is disclosed. The RESS may include on-board charging equipment having at least two on-board control modules (OBCMs); and a controller in communication with the on-board charging equipment. The controller may be configured to execute a control algorithm to precondition the on-board charging equipment.

Preconditioning the on-board charging equipment may include determining, via the controller, whether a vehicle charging event will occur within a predetermined period of time; determining, via the controller, whether an initial temperature of the on-board charging equipment is below a first predetermined temperature; and increasing the initial temperature of the on-board charging equipment prior to the vehicle charging event when it is determined that the vehicle charging event will occur within the predetermined period of time and the initial temperature of the on-board charging equipment is below the first predetermined temperature. The initial temperature of the on-board charging equipment may be increased using a charging and discharging loop.

Increasing the initial temperature of the on-board charging equipment may further include turning on communication, via the controller, between the at least two OBCMs and the controller when it is determined that the vehicle charging event will occur within the predetermined period of time and the at least two OBCMs are below the first predetermined temperature; connecting, via the controller, the at least two OBCMs to a high-voltage bus, wherein the at least two OBCMs includes a first OBCM and a second OBCM; enabling, via the controller, the first OBCM in an AC output mode; and enabling, via the controller, the second OBCM in a DC output mode.

The first OBCM may be operable to convert direct current (DC) power from the RESS to alternating current (AC) power; and wherein the second OBCM is operable to convert AC power from the first OBCM to DC power.

The charging and discharging loop may include receiving, via the first OBCM, DC power from the RESS; converting, via the first OBCM, the DC power from the RESS to AC power; delivering, via the high-voltage bus, the AC power from the first OBCM to the second OBCM; converting, via the second OBCM, the AC power from the first OBCM to DC power; and delivering, via the high-voltage bus, the DC power from the second OBCM back to the RESS.

Preconditioning the on-board charging equipment includes repeatedly cycling the charging and discharging loop, via the controller, to increase the initial temperature of the on-board charging equipment. The repeated cycling of the charging and discharging loop may be discontinued, via the controller, when the initial temperature of the on-board charging equipment reaches a second predetermined temperature or a vehicle charging event indicator is received.

When the repeated cycling of the charging and discharging loop is discontinued, communication with the at least two OBCMs, via the controller, may be turned off, and the at least two OBCMs may be disconnected, via the controller, from the high-voltage bus.

The vehicle charging event indicator may include a charge port door open indicator.

The control algorithm to precondition the on-board charging equipment may be executed when the vehicle is not connected to an AC power source, or when the vehicle is connected to the AC power source and a diverter switch, in communication with the vehicle and the AC power source, is in an open position.

According to another aspect of the disclosure, an electrified vehicle may include a rechargeable energy storage system (RESS), on-board charging equipment having at least two on-board control modules (OBCMs), which may be in communication with the RESS, and a controller in communication with the on-board charging equipment is disclosed.

The controller may be configured to execute a control algorithm to precondition the on-board charging equipment.

Preconditioning the on-board charging equipment may include determining, via the controller, whether a vehicle charging event will occur within a predetermined period of time; determining, via the controller, whether an initial temperature of the on-board charging equipment is below a first predetermined temperature; and increasing the initial temperature of the on-board charging equipment prior to the vehicle charging event when it is determined that the vehicle charging event will occur within the predetermined period of time and the initial temperature of the on-board charging equipment is below the first predetermined temperature, wherein the initial temperature of the on-board charging equipment is increased using a charging and discharging loop.

Therefore, by preconditioning the on-board charging equipment of an electrified vehicle including a rechargeable energy storage system (RESS), the initial temperature of the on-board charging equipment is increased to a predetermined temperature prior to initiation and/or commencement of a vehicle charging event, resulting in an increase in the initial charging speed, and the effectiveness of charging during the vehicle charging event.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is a schematic illustration of an electrified vehicle including a rechargeable energy storage system (RESS) according to the present disclosure.

FIG. 2 is a flow chart illustrating a method of preconditioning on-board charging equipment in a vehicle including a RESS according to the present disclosure.

FIG. 3 is a schematic illustration of a charging and discharging loop according to the present disclosure.

The appended drawings are not necessarily to scale, and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

Referring now to the drawings, wherein like numerals indicate like parts in several views, a method of predictively charging a vehicle including a rechargeable energy storage system (RESS), and a predictively smart charging vehicle including a RESS, are shown and described herein.

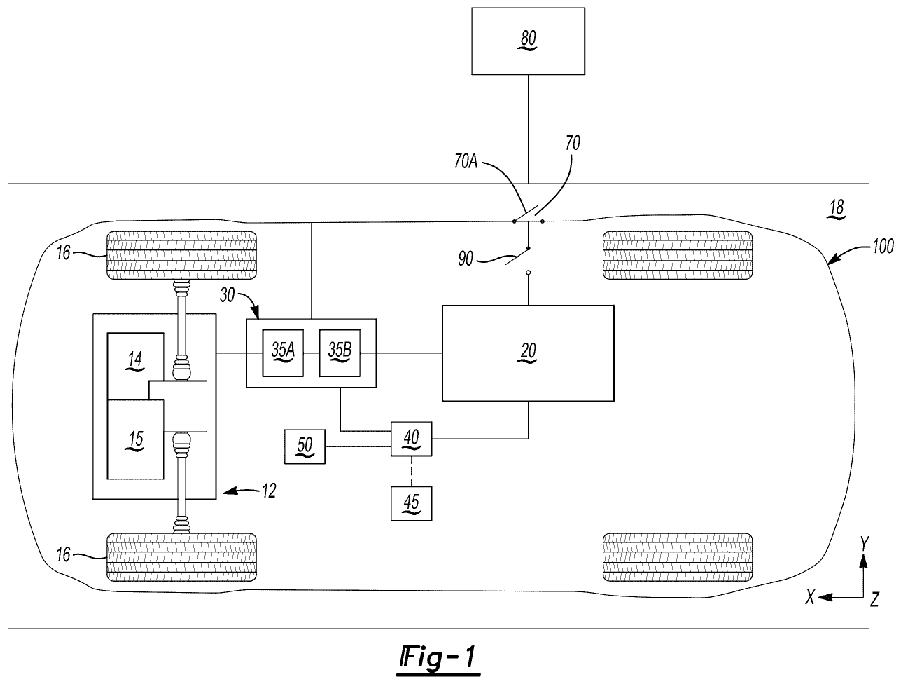

As illustrated in FIG. 1, an electrified vehicle 100 includes a powertrain 12. The vehicle 100 may include, but is not limited to, a commercial vehicle, an industrial vehicle, a passenger vehicle, an aircraft, a watercraft, a train or the like.

The powertrain 12 includes a power-source 14 configured to generate a power-source torque T (not shown) for propulsion of the vehicle 100 via driven wheels 16 relative to a road surface 18. The power-source 14 is depicted as an electric motor-generator.

As further illustrated in FIG. 1, the powertrain 12 may also include an additional power-source 15, such as an internal combustion engine. The power-sources 14 and 15 may act in concert to power the vehicle 100.

The vehicle 100 includes a rechargeable energy storage system (RESS) 20, on-board charging equipment 30 including at least two on-board charging modules OBCMs 35, a controller 40, and a user interface 50. While the RESS 20 and on-board charging equipment 30 are illustrated as separate components, it should be appreciated that the on-board charging equipment 30 may be incorporated into the RESS 20.

The RESS 20 is configured to store electrical power through heat-producing electro-chemical reactions and discharge DC power for energizing the vehicle 100 during use and/or to power a structure, for example, but not limited to a house, during a power disruption or outage.

The controller 40 is in communication with the RESS 20, the on-board charging equipment 30 and the user interface 50. The controller 40 is programmable and may include a central processing unit (CPU) that regulates various functions of the vehicle 100, the RESS 20, and/or the on-board charging equipment 30.

In either of the above configurations, the controller 40 includes a processor and tangible, non-transitory memory, which includes instructions for operation of vehicle 100, the RESS 20, and the on-board charging equipment 30 programmed therein. The memory may be an appropriate recordable medium that participates in providing computer-readable data or process instructions. Such a recordable medium may take many forms, including, but not limited to, non-volatile media and volatile media.

Non-volatile media for the controller 40 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection.

Memory of the controller 40 may also include a flexible disk, hard disk, magnetic tape, another magnetic medium, a CD-ROM, DVD, another optical medium, etc. The controller 40 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the controller 40 or accessible thereby, including, but not limited to predictive algorithms, may be stored in the memory and automatically executed to provide the required functionality of the vehicle 100, the RESS 20, and the on-board charging equipment 30.

The controller 40 is disposed in vehicle 100 and is in communication with the RESS, the on-board charging equipment 30, the user interface 50, and the vehicle 100.

The vehicle 100 includes a charge port 70 that has a charge port door 70A for connecting the vehicle to an external power supply 80, which may be located at, for example but not limited to, an owner's place of residence, place of work, power supply station, or the like.

The external power supply 80 is operable to provide alternating current (AC) power to the vehicle 100 as required by the controller 40. A diverter switch 90, in communication with the external power supply 80 and the vehicle 100, allows the vehicle 100 to be attached to the external power supply 80, while selectively preventing AC power from flowing from the external power supply 80 to charge the vehicle 100. While the diverter switch 90 is schematically illustrated as being disposed internal to the vehicle 100, it should be appreciated that the diverter switch 90 may be disposed external to the vehicle 100.

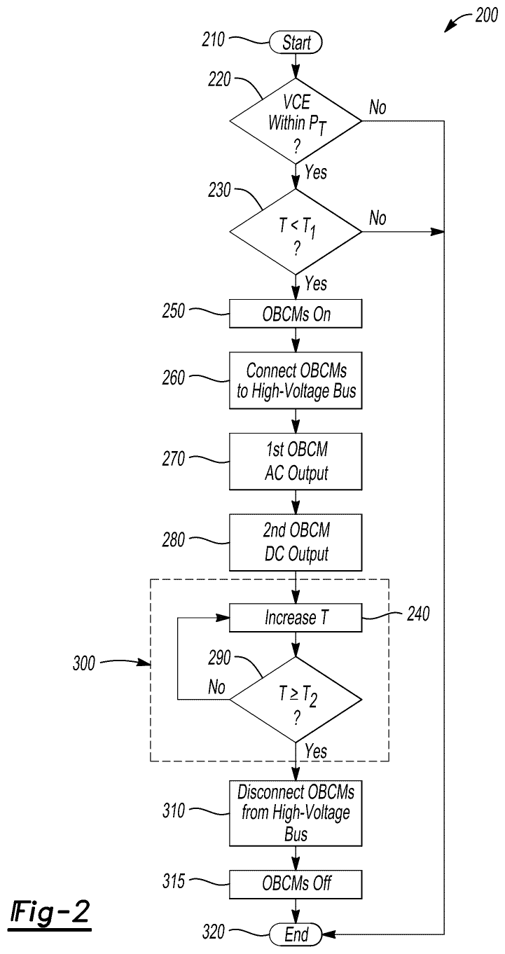

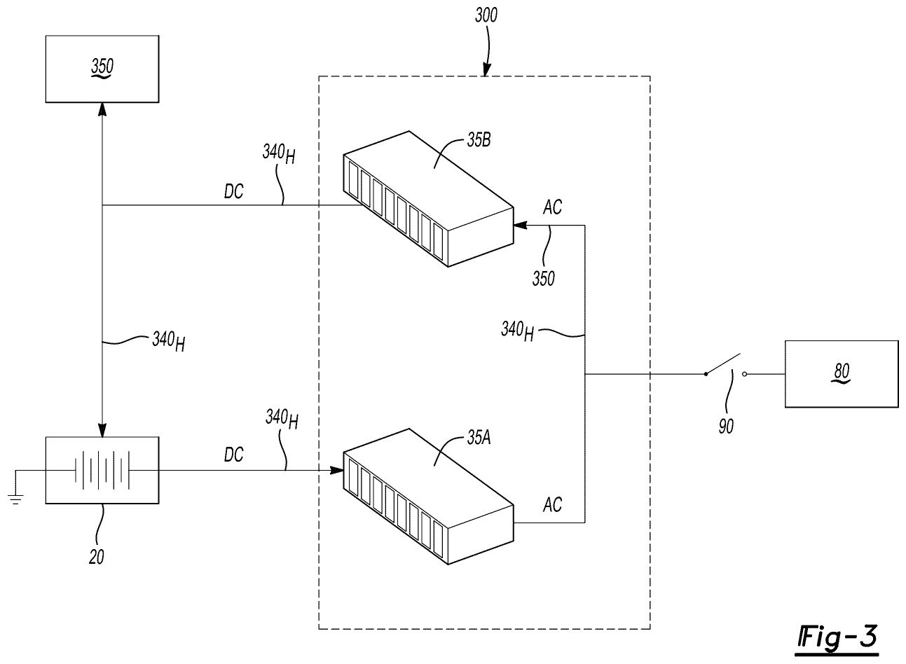

As schematically illustrated in FIG. 2, a method 200 of preconditioning on-board charging equipment 30 for a vehicle 100 including a rechargeable energy storage system (RESS) 20 is disclosed. The method 200 starting at 210 includes determining whether a vehicle charging event VCE will occur within a predetermined period of time PT, as shown at 220; determining whether an initial temperature T of the on-board charging equipment 30 is below a first predetermined temperature T1, as shown at 230; and increasing the initial temperature T of the on-board charging equipment 30 prior to the vehicle charging event VCE when it is determined that the vehicle charging event VCE will occur within the predetermined period of time PT and the initial temperature T of the on-board charging equipment 30 is below the first predetermined temperature T1, as shown at 240, such that the initial temperature T of the on-board charging equipment 30 is increased using a charging and discharging loop 300 (FIG. 3).

It should be appreciated that the VCE may include, but is not limited to, an alternating current vehicle charging event.

Whether the VCE will occur within the predetermined period of time PT may be determined based upon, for example but not limited to, customer input to a user interface 50 that includes, for example but is not limited to, a specific time for the VCE to occur, or a customer anticipated departure time.

Whether the VCE will occur within the predetermined period of time PT may also be predictively determined by the controller 40 based on a predictive algorithm stored in the controller 40 and input received by the controller 40 from, for example but not limited to, a navigation system 45 that may include a global positioning system (GPS). The navigation system 45 may be disposed within the vehicle 100.

Input from the navigation system 45 may include, for example but not limited to, location information related to locations of vehicle charging stations (not shown). The predictive algorithm may use the locations of vehicle charging stations along a travel route to determine whether the VCE will occur within the predetermined period of time PT.

Increasing the initial temperature T of the on-board charging equipment 30, shown at 240, further includes: turning on communication between the at least two OBCMs 35A, 35B and the controller 40, as shown at 250, when it is determined that the vehicle charging event VCE will occur within the predetermined period of time PT, as shown at 220, and the at least two OBCMs 30A, 30B are below the first predetermined temperature T1, as shown at 230; and connecting the at least two OBCMs 35A, 35B to a high-voltage bus 340H (FIG. 3), as shown at 260.

The at least two OBCMs 35A, 35B include a first OBCM 35A and a second OBCM 35B. At least one of the OBCMs 35A, 35B will be put into an AC output mode, to pull power from the RESS 20, and the other of the at least two OBCMs will be put in a DC output mode to use the power converted from the at least one of the OBCMs 35A, 35B. While at least two OBCMs are disclosed, it should be appreciated that multiple OBCMs may be included

The method 200 further includes: enabling the first OBCM 35A in an AC output mode, as shown at 270; and enabling the second OBCM 35B in a DC output mode, as shown at 280.

As schematically illustrated in FIG. 3, the first OBCM 35A is operable to convert high-voltage direct current (DC) power DC from the RESS 20 to alternating current (AC) power AC, and the second OBCM 35B is operable to convert AC power AC from the first OBCM 35A to high-voltage DC power DC.

The method 200 further includes delivering, via the high-voltage bus 340H, high-voltage DC power DC from the second OBCM 35B to a low-voltage auxiliary device 350, for example but not limited to a battery heater, an auxiliary power module, and/or other 12V device, each of which may include an internal voltage converter (not shown) that is operable to convert the high-voltage DC power DC to low-voltage DC power for use by the low-voltage auxiliary device 350.

According to an aspect of the disclosure, the charging and discharging loop 300 includes: receiving, via the first OBCM 35A, DC power DC from the RESS 20; converting, via the first OBCM 35A, the DC power DC from the RESS 20 to AC power AC; delivering, via the high-voltage bus 340H, the AC power AC from the first OBCM 35A to the second OBCM 35B; converting, via the second OBCM 35B, the AC power AC from the first OBCM 35A to high-voltage DC power DC; and delivering, via the high-voltage bus 340H, the high-voltage DC power DC from the second OBCM 35B back to the RESS 20.

The charging and discharging loop 300 may be cycled repeatedly to increase the initial temperature T of the on-board charging equipment 30.

The repeated cycling of the charging and discharging loop 300 is discontinued when the initial temperature T of the on-board charging equipment 30 reaches a second predetermined temperature T2 or a vehicle charging event indicator VCEI is received from the controller 40, for example but not limited to, from the user interface 50, the vehicle charge port 70 and/or the vehicle charge port door 70A via a sensor (not shown) or other external input, for example but not limited to, input from a smart charger app, which may include customer input, for example, a customer anticipated departure time.

The method 200 further includes disconnecting the at least two OBCMs 35A, 35B from the high-voltage bus 340H, as shown at 310; and turning off communication between the at least two OBCMs 35A, 35B and the controller 40, as shown at 315, when the repeated cycling of the charging and discharging loop 300 is discontinued, as shown at 301.

The vehicle charging event indicator VCEI may include a charge port door open indicator.

The method 200 of preconditioning may occur when the vehicle 100 is not connected to an AC power source 80, or when the vehicle 100 is connected to the AC power source 80 and a diverter switch 90, in communication with the vehicle 100 and the AC power source 80, is in an open position.

According to another aspect of the disclosure, a rechargeable energy storage system (RESS) 20 for a vehicle 100 is disclosed. The RESS 20 includes on-board charging equipment 30 having at least two on-board control modules (OBCMS) 35A. 35B; and a controller 40 in communication with the on-board charging equipment 30. The controller 40 is configured to execute a control algorithm including the method 200 to precondition the on-board charging equipment 30 discussed above.

According to another aspect of the disclosure, an electrified vehicle 100 includes a rechargeable energy storage system (RESS) 20, on-board charging equipment 30 having at least two on-board control modules (OBCMS) 35A, 35B, in communication with the RESS 20, and a controller 40 in communication with the on-board charging equipment 30 is also disclosed.

The controller 40 is configured to execute a control algorithm including the method 200 to precondition the on-board charging equipment 30 discussed above.

Therefore, by preconditioning the on-board charging equipment of a vehicle including a rechargeable energy storage system (RESS) prior to initiation and/or commencement of a vehicle charging event, through the repeated charging and discharging of the on-board charging equipment, the initial charging speed is increased, as is the effectiveness of charging during the vehicle charging event.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method of preconditioning on-board charging equipment for a vehicle including a rechargeable energy storage system (RESS), the method comprising:
determining whether a vehicle charging event will occur within a predetermined period of time;
determining whether an initial temperature of the on-board charging equipment is below a first predetermined temperature; and
increasing the initial temperature of the on-board charging equipment prior to the vehicle charging event when it is determined that the vehicle charging event will occur within the predetermined period of time and the initial temperature of the on-board charging equipment is below the first predetermined temperature, wherein the initial temperature of the on-board charging equipment is increased using a charging and discharging loop.

2. The method of preconditioning as recited in claim 1, wherein the on-board charging equipment includes at least two on-board charging modules (OBCMs); and
wherein increasing the initial temperature of the on-board charging equipment further includes:
turning on communication between the at least two OBCMs and the controller when it is determined that the vehicle charging event will occur within the predetermined period of time and the at least two OBCMs are below the first predetermined temperature;
connecting the at least two OBCMs to a high-voltage bus, wherein the at least two OBCMs includes a first OBCM and a second OBCM;
enabling the first OBCM in an AC output mode; and
enabling the second OBCM in a DC output mode.

3. The method of preconditioning as recited in claim 2, wherein the first OBCM is operable to convert direct current (DC) power from the RESS to alternating current (AC) power; and wherein the second OBCM is operable to convert AC power from the first OBCM to DC power.

4. The method of preconditioning as recited in claim 3, including:
delivering, via the high-voltage bus, DC power from the second OBCM to a low-voltage auxiliary device.

5. The method of preconditioning as recited in claim 3, wherein the charging and discharging loop includes:
receiving, via the first OBCM, DC power from the RESS;
converting, via the first OBCM, the DC power from the RESS to AC power;
delivering, via the high-voltage bus, the AC power from the first OBCM to the second OBCM;
converting, via the second OBCM, the AC power from the first OBCM to DC power; and
delivering, via the high-voltage bus, the DC power from the second OBCM back to the RESS.

6. The method of preconditioning as recited in claim 5, wherein the charging and discharging loop is cycled repeatedly to increase the initial temperature of the on-board charging equipment.

7. The method of preconditioning as recited in claim 6, wherein the repeated cycling of the charging and discharging loop is discontinued when the initial temperature of the on-board charging equipment reaches a second predetermined temperature or a vehicle charging event indicator is received.

8. The method of preconditioning as recited in claim 7, further including:
disconnecting the at least two OBCMs from the high-voltage bus; and
turning off communication between the at least two OBCMs and the controller when the repeated cycling of the charging and discharging loop is discontinued.

9. The method of preconditioning as recited in claim 7, wherein the vehicle charging event indicator includes a charge port door open indicator.

10. The method of preconditioning as recited in claim 1, wherein the preconditioning occurs when the vehicle is not connected to an AC power source, or when the vehicle is connected to the AC power source and a diverter switch, in communication with the vehicle and the AC power source, is in an open position.

11. A rechargeable energy storage system (RESS) for a vehicle including:
on-board charging equipment having at least two on-board control modules (OBCMs); and
a controller in communication with the on-board charging equipment, wherein the controller is configured to execute a control algorithm to precondition the on-board charging equipment, wherein preconditioning the on-board charging equipment includes:
determining, via the controller, whether a vehicle charging event will occur within a predetermined period of time;
determining, via the controller, whether an initial temperature of the on-board charging equipment is below a first predetermined temperature; and
increasing the initial temperature of the on-board charging equipment prior to the vehicle charging event when it is determined that the vehicle charging event will occur within the predetermined period of time and the initial temperature of the on-board charging equipment is below the first predetermined temperature, wherein the initial temperature of the on-board charging equipment is increased using a charging and discharging loop.

12. The RESS as recited in claim 11, wherein increasing the initial temperature of the on-board charging equipment further includes:
turning on communication, via the controller, between the at least two OBCMs and the controller when it is determined that the vehicle charging event will occur within the predetermined period of time and the at least two OBCMs are below the first predetermined temperature;
connecting, via the controller, the at least two OBCMs to a high-voltage bus, wherein the at least two OBCMs includes a first OBCM and a second OBCM;
enabling, via the controller, the first OBCM in an AC output mode; and
enabling, via the controller, the second OBCM in a DC output mode.

13. The RESS as recited in claim 12, wherein the first OBCM is operable to convert direct current (DC) power from the RESS to alternating current (AC) power; and wherein the second OBCM is operable to convert AC power from the first OBCM to DC power.

14. The RESS as recited in claim 13, wherein the charging and discharging loop includes:
receiving, via the first OBCM, DC power from the RESS;
converting, via the first OBCM, the DC power from the RESS to AC power;
delivering, via the high-voltage bus, the AC power from the first OBCM to the second OBCM;
converting, via the second OBCM, the AC power from the first OBCM to DC power; and
delivering, via the high-voltage bus, the DC power from the second OBCM back to the RESS.

15. The RESS as recited in claim 14, wherein preconditioning the on-board charging equipment includes repeatedly cycling the charging and discharging loop, via the controller, to increase the initial temperature of the on-board charging equipment.

16. The RESS as recited in claim 15, wherein the repeated cycling of the charging and discharging loop is discontinued, via the controller, when the initial temperature of the on-board charging equipment reaches a second predetermined temperature or a vehicle charging event indicator is received.

17. The RESS as recited in claim 16, further including:
disconnecting, via the controller, the at least two OBCMs from the high-voltage bus; and
turning off communication, via the controller, between the at least two OBCMs and the controller when the repeated cycling of the charging and discharging loop is discontinued.

18. The RESS as recited in claim 17, wherein the vehicle charging event indicator includes a charge port door open indicator.

19. The RESS as recited in claim 11, wherein the control algorithm to precondition the on-board charging equipment is executed when the vehicle is not connected to an AC power source, or when the vehicle is connected to the AC power source and a diverter switch, in communication with the vehicle and the AC power source, is in an open position.

20. An electrified vehicle including:
a rechargeable energy storage system (RESS);
on-board charging equipment having at least two on-board control modules (OBCMs), wherein the on-board charging equipment is in communication with the RESS; and
a controller in communication with the on-board charging equipment, wherein the controller is configured to execute a control algorithm to precondition the on-board charging equipment, wherein preconditioning the on-board charging equipment includes:
determining, via the controller, whether a vehicle charging event will occur within a predetermined period of time;
determining, via the controller, whether an initial temperature of the on-board charging equipment is below a first predetermined temperature; and
increasing the initial temperature of the on-board charging equipment prior to the vehicle charging event when it is determined that the vehicle charging event will occur within the predetermined period of time and the initial temperature of the on-board charging equipment is below the first predetermined temperature, wherein the initial temperature of the on-board charging equipment is increased using a charging and discharging loop.
